(19) United States
(12) Patent Application Publication
(10) Pub. No.: US 2006/0113046 A1
(43) Pub. Date: Jun. 1, 2006

(54) Stiffened parts for window covering and methods for making the same

(76) Inventors: Kendall W. Prince, Layton, UT (US); Matt A. Stott, Syracuse, UT (US); Don A. Patterson, Gilbert, AR (US)

Correspondence Address: KIRTON AND MCCONKIE;1800 EAGLE GATE TOWER, 60 EAST SOUTH TEMPLE, P O BOX 45120, SALT LAKE CITY, UT, 84145-0120, US

(21) Appl. No.: 11/127,610

(22) Filed: May 12, 2005

Related U.S. Application Data
(60) Provisional application No. 60/570,191, filed on May 12, 2004.

(51) Int. Cl. E06B 3/12

(52) U.S. Cl. 160/236

(57) ABSTRACT

A window covering component comprising a substrate having a modulus of elasticity and a stiffener having a higher modulus of elasticity than the substrate and positioned substantially away from the plane in which the substrate would otherwise tend to deform.

### 1. RELATED APPLICATIONS

This application claims priority to U.S. provisional application Ser. No. 60/570,191, filed May 12, 2004.

### BACKGROUND

2. Field of the Invention

The present invention relates generally to blinds or other coverings for windows or similar architectural openings. More particularly, the present invention relates to stiffened parts for window coverings and methods for making the stiffened parts.

3. Background Information

Many types of covering are used to cover architectural openings in order to provide privacy, assist with climate control, and to adjust the amount of daylight entering through an opening. The most widely used variety of covering for these purposes is a window blind, sometimes called a “Venetian” blind. Such a window covering comprises a series of spaced-apart slats or louvers assembled parallel to each other. In some cases, the slats are disposed horizontally with respect to the window; in others, the slats are disposed vertically.

Window blinds constructed of multiple wooden slats are popular for their strength, appearance, and durability. But because wooden slats are also relatively expensive, many window blinds use slats constructed of various alternatives to wood. These alternatives include various types of metal, such as aluminum; vinyl; PVC foam; ABS wood composite; plywood; solid or foamed thermoplastic resins; or a combination of any of these. While generally less expensive than solid wood, slats constructed of these wood-alternatives are either inferior to solid wood slats in terms of beam strength, or else are even more expensive to manufacture than solid wood. The inferior beam strength of wood-alternatives imposes structural limits on the span width of a slat when used in a horizontal configuration. In other words, wood-alternatives require more support members to span a given breadth of architectural opening as compared to a solid wood slat. Support members generally take the form of ladders in which slats are positioned. Using a greater number of ladders prevents sagging of slats, but also increases manufacturing costs and decreases the aesthetic and functional characteristics of the finished window blind. Typically, solid wood slats require a ladder support every 21 to 24 inches; wood-alternatives such as foamed thermoplastic resins or wood composites require a ladder support every 10 to 12 inches along the length of a slat.

In the window coverings industry, it is desirable for slats to be rigid in nature. With respect to horizontally-oriented blinds, rigidity is also necessary in order to maintain a high level of closure for privacy and security. Known methods of stiffening slats include inserting aluminum rods or wood into an extruded slat, or introducing aluminum at the extruder head where PVC is then joined with the inserted aluminum. These methods are inefficient and are useful for only a small number of very specific applications.

### SUMMARY OF THE INVENTION

The present invention relies upon the differing strengths of materials to create a window covering part, such as, for example, a slat, having a much greater stiffness than prior art window covering parts, without the high materials or manufacturing costs previously associated with a higher degree of stiffness.

In one embodiment of the present invention, a slat is formed of a substantially flat, board-like substrate. A second material is affixed to the substrate and causes the substrate to be stiffer than without the second material. In a preferred embodiment, the substrate is a non-wood or wood-alternative such as MDF or a foamed thermoplastic resin. In a preferred embodiment, the second material is a paper-like material or a metal such as aluminum. Preferred methods of the present invention involve adhering the second material to the substrate along substantially the entire length of the substrate; to effectively provide a greater stiffening for increased span lengths, at least substantially all of the substrate lying between support ladders of a horizontal window blind must include the stiffening second material.

Accordingly, it is an object of some embodiments of the present invention to provide a window covering part stiffened by coupling a stiffener to at least a portion of a substrate.

It is another object of some embodiments of the present invention to provide a window covering part comprising a planar stiffener coupled to a substrate, the resulting part being a strengthened part for a window covering such that the part is significantly superior in strength and rigidity as compared to a part of the same thickness absent the stiffener.

It is yet another object of some embodiments of the present invention to provide a part comprising a planar stiffener coupled to at least two surfaces of a substrate.

It is another object of some embodiments of the present invention to provide methods for making parts for window coverings wherein the rigidity of the parts is significantly increased by applying a stiffener to a substrate.

### BRIEF DESCRIPTION OF THE DRAWINGS

The foregoing and other objects and features of the present invention will become more fully apparent from the accompanying drawings when considered in conjunction with the following description. Although the drawings depict only typical embodiments of the invention and are thus not to be deemed as limiting the scope of the invention, the accompanying drawings help explain the invention in added detail.

FIG. 1 is a perspective view of a stiffened window covering part in accordance with one embodiment of the present invention.

FIGS. 2A-2F are views of various embodiments of the stiffened window covering part of the present invention.

FIG. 3 illustrates a perspective view of an alternative embodiment of the present invention in which a foamed thermoplastic substrate is wrapped with a paper-like stiffening material.

### DETAILED DESCRIPTION OF THE INVENTION

The following detailed description, in conjunction with the accompanying figures (hereby expressly incorporated as part of this detailed description), sets forth specific numbers, materials, and configurations in order to provide a thorough understanding of the present invention. The following detailed description, in conjunction with the drawings, will enable one skilled in the relevant art to make and use the present invention.

A purpose of this detailed description being to describe the invention so as to enable one skilled in the art to make and use the present invention, the following description sets forth various specific examples, also referred to as “embodiments,” of the present invention. While the invention is described in conjunction with specific embodiments, it will be understood, because the embodiments are set forth for explanatory purposes only, that this description is not intended to limit the invention to these particular embodiments. Indeed, it is emphasized that the present invention can be embodied or performed in a variety of ways. The figures and detailed description are merely representative of particular embodiments of the present invention.

The amount of sagging present in a horizontally disposed window coverings slat is a function of the modulus of elasticity of the material of which the slat is constructed, the cross-sectional area of the slat, and the length of the slat between support members or ladders. A slat constructed of a material having a generally higher modulus of elasticity (such as steel) will be stiffer (i.e. it will sag less) over an equal distance compared to a slat constructed of a material having a generally lower modulus of elasticity (such as PVC). Further, a slat having a generally larger cross-sectional area will be stiffer over a greater length than will a slat having a generally smaller cross sectional area. Constructing a slat of materials having a high modulus of elasticity is generally prohibitively expensive; constructing a slat with a large cross-sectional area detracts significantly from the aesthetic characteristics desired in a window covering, and also imposes additional materials costs during manufacturing.

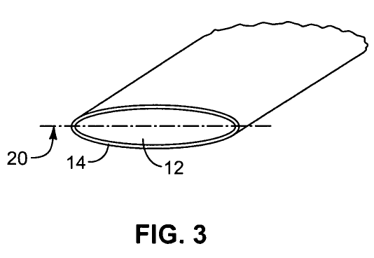

The cross-sectional shape of a window slat also affects the tendency of the slat to sag over its length. This is evident when one considers the shape of an I-beam or of a floor joist used in the construction of buildings. One can visualize a plane in which any beam is subject to the force of gravity and is therefore subject to sagging. This is illustrates in reference to an embodiment of the present invention at 20 in FIG. 3. The design of an I-beam or joist positions the material of the beam more distantly from the plane in which gravity is causing the sagging to occur. This increases the stiffness of the beam or joist—it's ability to resist gravity and not sag.

Mathematically, the moment of inertia of any beam is a finction of the shape of the beam and of the density of the materials used to construct the beam. A higher moment of inertia equates to a greater stiffness.

If we consider a window covering slat as a beam being analyzed to determine its moment of inertia, the present invention discloses a method of increasing the moment of inertia of the beam, and thus reduces the sagging of the beam (i.e. increases its stiffness) by positioning materials having a higher density (which equates generally to a higher modulus of elasticity) more distant from the plane 20 in which gravity is exerting a force to cause sagging. The material having a higher modulus of elasticity is held in position by being coupled or affixed to a material having a lower modulus of elasticity (and generally lower materials cost).

By combining materials having higher and lower moduli of elasticity, positioned so as to increase the moment of inertia of the constructed beam, the present invention permits manufacturing of a window covering slat that is much stiffer than prior art slats compared to the cost of the materials used to construct it.

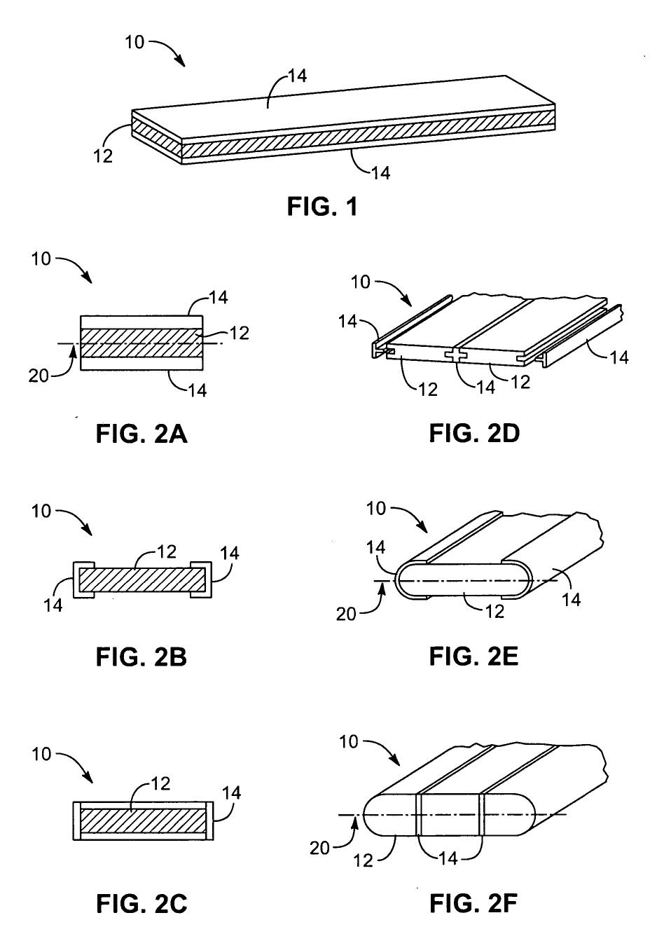

FIG. 1 shows a window covering part (such as, for example, a louver or slat) 10 according to a simple embodiment of the present invention. Part 10 comprises a substantially flat substrate 12 and a stiffener 14 coupled to the upper and lower surfaces of substrate 12. In a preferred embodiment, substrate 12 is constructed of foamed or solid extruded thermoplastic resin; stiffener 14 comprises paper or a paper-like substance having a higher modulus of elasticity than substrate 12. Stiffener 14 is coupled or affixed to substrate 12 along substantially the entire length of substrate 12. In particular, stiffener 14 is affixed or adhered to substrate 12 along substantially the entire length of substrate 12 lying between ladder supports in a horizontally disposed Venetian-style window blind.

The substrate alone, in a preferred embodiment, has a relatively lower modulus of elasticity compared to the stiffener. Operating alone, the substrate would have a stiffness or a tendency to sag roughly equivalent to many window covering slats in the prior art that are made of similar materials.

However, by positioning the second material, stiffener 14, at a distance from the plane 20 of the substrate along which sagging will occur, substrate 12 and stiffener 14 operate as a single unit having a higher moment of inertia. The cross sectional area of the two components of FIG. 1 is shown in FIG. 2A. To operate effectively according to the present invention, the two materials must be coupled to one another so that they cannot operate (or sag) independently of one another. That is, multiple layers adhere to one another to operate as a single unit with much greater strength. In accordance with the present invention, this technique is applied in components of window coverings, and further, the technique employs two different materials having different moduli of elasticity so as to provide increased stiffness without resort to size or materials costs that would be prohibitive in the window coverings industry.

Examples of suitable substrates 12 include, but are not limited to: foam PVC, polyurethane foam, phenol-based foam, ABS, OSB, wood foam, wood, plywood, wood veneer, sheet foam, thermoplastics, composites, cellulose, ultra-light density fiberboard, medium-density fiberboard, medium low-density fiberboard, or a combination of any of the above. In a preferred embodiment, substrate 12 is a non-wood or wood-alternative such as polyurethane foam.

Examples of stiffeners 14 include, but are not limited to; saturated paper, aluminum, pre-impregnated paper, metal, fiberglass, decorative laminate, thermoplastic resin, thermoset plastic, composites, or any of the above.

Numerous configurations of a substrate and a stiffener are encompassed within the scope of the present invention without departing from its essential characteristics.

Depending on manufacturing requirements, aesthetic considerations, or other needs, stiffeners 14 may be placed on any of the sides of substrate 12 or even within substrate 12. For example, FIG. 2B shows stiffener 14 applied to the left and right sides of substrate 12; FIG. 2C shows stiffener 14 coupled to each of the four sides of a rectangular part 10; FIG. 2D shows stiffener 14 coupled to the sides of substrate 12 as well as integrated in the center portion of substrate 12, essentially dividing substrate 12 into two portions. In this embodiment, a very narrow slat may be constructed of a substance such as a foamed thermoplastic or wood composite. When a stiffener such as an aluminum strip is added to substrate 12 as shown in FIG. 2D, the resulting part is significantly stiffer, without adding significantly to the cost of manufacturing, as would be required by creating a part of solid aluminum. FIG. 2E shows stiffener 14 coupled to the curved sides of a substrate 12; and FIG. 2F shows stiffener 14 integrated with substrate 12 in a manner similar to that shown in FIG. 2D.

The substrate used in the present invention may have any suitable cross-sectional form, such as, without limitation, an airfoil, a rectangle, an elongate horizontal oval, a square, a trapezoid, or a circle.

As a final, non-limiting example, FIG. 3 shows substrate 12 having an airfoil shape. In a preferred embodiment, substrate 12 comprises MDF or a foamed thermoplastic resin. In FIG. 3, stiffener 14 entirely wraps or encloses the outer surface of substrate 12. In a preferred embodiment, stiffener 14 comprises paper.

As these few example embodiments of the present invention demonstrate, its essential characteristics are the differing moduli of elasticity of the substrate and the stiffener, and the positioning of the stiffener in relation to the plane 20 in which the part 10 is induced to sag under the force of gravity. By relying on the higher modulus of elasticity of a stiffening material positioned away from the plane of sagging, the part exhibits an increased moment of inertia, with the result being an effect similar to a laminate beam or I-beam.

Stiffener 14 may be coupled to substrate 12 by any suitable means. Examples of coupling means include but are not limited to: mechanical attachment, heat-based attachment, chemical reaction, and adhesives. Adhesives may include, for example: thermosetting plastics, thermoplastic resins, hot melts, contact glue, B-stage glue, construction adhesive, or any other suitable adhesive.

Moreover, decorations of any type known in the art (which are not illustrated in the attached Figures) may be coupled to or incorporated into a part 10 made according to the present invention by any means, including the above-mentioned coupling means, either by making a decoration part of stiffener 14 as it is affixed to substrate 12; or by adding a separate decorative element to part 10 after it is constructed of a substrate 12 and a stiffener 14. Exemplary decorations include, but are not limited to: paint, powder coating, roll coating, curtain coating, spray coating, flow coating, extruded coatings, vinyl or foil wrapping, heat transfers, thermoplastic or thermoset coating, wood veneers, embossing, texturing, and others. Indeed, stiffener 14 may itself be decorative in nature without detracting from its functional characteristic as herein disclosed. Non-limiting examples include use of the following as stiffeners: white paper, painted aluminum, decorated phenolic paper, epoxy, or thermoplastic resins.

Though discussed principally as a window covering slat for use in horizontally disposed Venetian-style window blinds, those skilled in the art will immediately recognize that the present invention has a variety of useful applications in the window coverings and window manufacturing industries. For example, parts 10 can be used as horizontal or vertical window blind slats (such as in Venetian blinds); as shutter parts; as drapery poles; or as comers, toppers, and valances.

Methods of making the present invention may involve coupling the stiffener to the substrate simultaneous with the production of the substrate. This contemporaneous production may minimize production costs and provide for efficient manufacture of the slats.

It is underscored that the present invention may be embodied in other specific forms without departing from its spirit or essential characteristics. The described embodiments herein should be deemed only as illustrative.

What is claimed is:

1. A window covering part comprising
A length of a first material, said length having a cross-sectional perimeter and said first material having a first modulus of elasticity, and
A second material that is coupled to at least a portion of said perimeter of said first material along a substantially continuous portion of said length, wherein said second material has a second modulus of elasticity that is higher than said first modulus of elasticity.

2. The window covering part of claim 1 wherein said cross-sectional perimeter is substantially in the form selected from the group consisting of an airfoil, a rectangle, an elongate horizontal oval, a square, a trapezoid, and a circle.

3. The window covering part of claim 1 wherein said first material is selected from the group consisting of a thermoplastic resin, a foamed thermoplastic resin, wood, a wood-resin composite, plywood, fiberboard, and a thermoset plastic.

4. The window covering part of claim 1 wherein said second material is selected from the group consisting of saturated paper, pre-impregnated paper, fiberglass, decorative laminate, a thermoplastic resin, paper, aluminum, and steel.

5. The window covering part of claim 1 wherein said second material further comprises a decorative appearance on the exposed surface of said second material.

6. The window covering part of claim 1 further comprising a decorative material affixed to at least a portion of said second material.

7. A window covering part comprising
A first material, having a first length and a first modulus of elasticity, and
A second material, having a second length, said second length being substantially equal to said first length, where
Said first material is coupled to said second material along substantially all of said first length, and
Said second material has a second modulus of elasticity that is higher than said first modulus of elasticity.

8. The window covering part of claim 7 wherein said first material is selected from the group consisting of a thermoplastic resin, a foamed thermoplastic resin, wood, a wood-resin composite, plywood, fiberboard, and a thermoset plastic.

9. The window covering part of claim 7 wherein said second material is selected from the group consisting of saturated paper, pre-impregnated paper, fiberglass, decorative laminate, a thermoplastic resin, paper, aluminum, and steel.

10. The window covering part of claim 7 further comprising a decorative material affixed to at least a portion of the outer surface of said part.
